(19) United States
(12) Patent Application Publication
(10) Pub. No.: US 2022/0053123 A1
(43) Pub. Date: Feb. 17, 2022

(54) METHOD AND APPARATUS FOR INDEPENDENT AUTHENTICATION OF VIDEO

(71) Applicant: Comcast Cable Communications, LLC, Philadelphia, PA (US)

(72) Inventor: Jeffrey Ronald Wannamaker, London (CA)

(21) Appl. No.: 16/991,573

(22) Filed: Aug. 12, 2020

(51) Int. Cl. H04N 5/232; H04N 19/467

(52) U.S. Cl. CPC H04N 5/23229; H04N 19/467

(57) ABSTRACT

Systems and methods are described for the authentication of video. One or more witness devices may provide data that may be used to authenticate a video or a picture generated by a camera. A computing device comprising the camera or a separate camera device may be recording video or taking pictures and may discover one or more witness devices located nearby and held by users shown in the video or pictures. The one or more witness devices may provide authentication data to the computing device or the camera device. The computing device or camera device may encode the authentication data with the picture or video content. An authentication device may decode the authentication data to determine whether the video or picture is authentic and has been unaltered.

### BACKGROUND

Images and videos may be modified based on various techniques. For example, images and videos may be modified based on artificial intelligence and machine learning techniques. For example, images and videos may be modified based on deepfake technology. The modified images or videos may comprise combined images or videos or superimposed images or videos. Video or picture evidence may not be entirely trustworthy because video data may be generated to depict anyone doing almost anything. Fake, altered, or forged video or pictures may not be distinguished from authentic video or pictures. Improved video authentication techniques are desired.

### SUMMARY

Systems and methods are described for the authentication of video. One or more witness devices may provide data that may be used to authenticate a video or a picture generated by a camera. A computing device comprising the camera or a separate camera device may be recording video or taking pictures and may discover one or more witness devices located nearby. The one or more witness devices may be located in close proximity to the computing device or the camera device. For example, the one or more witness devices may be carried by people in the video or picture. The one or more witness devices may provide authentication data to the computing device or the camera device. The computing device or camera device may encode the authentication data with the video content or picture. The authentication data may be detected by another device that performs authentication of the video content or picture. The authentication device may decode the authentication data to determine whether the video or picture is authentic and has been unaltered.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows an example procedure for registering camera devices and witness devices;

FIG. 3 shows an example discovery procedure;

FIG. 4 shows an example of metadata used for authenticating video;

FIG. 5 shows an example method;

FIG. 6 shows an example method;

FIG. 7 shows an example method; and

FIG. 8 shows an example operating environment.

### DETAILED DESCRIPTION OF ILLUSTRATIVE EMBODIMENTS

Systems and methods are described for the authentication of video. One or more devices may provide authentication data. Devices configured to generate and/or provide the authentication data may be referred to herein as witness devices. The authentication data may verify that the video was indeed captured by the camera. Determining that the video was indeed captured by the camera may verify that the video was not altered, faked, or forged. A computing device or the camera device may be recording video and may desire for that video to be able to be authenticated. The computing device or the camera device may discover one or more witness devices that may provide authentication data to the computing device or camera device. The computing device or camera device may provide the authentication data and other information associated with the video to a server. The authentication data may be accessed by another device that authenticates the video to verify that the video was not altered, faked, or forged.

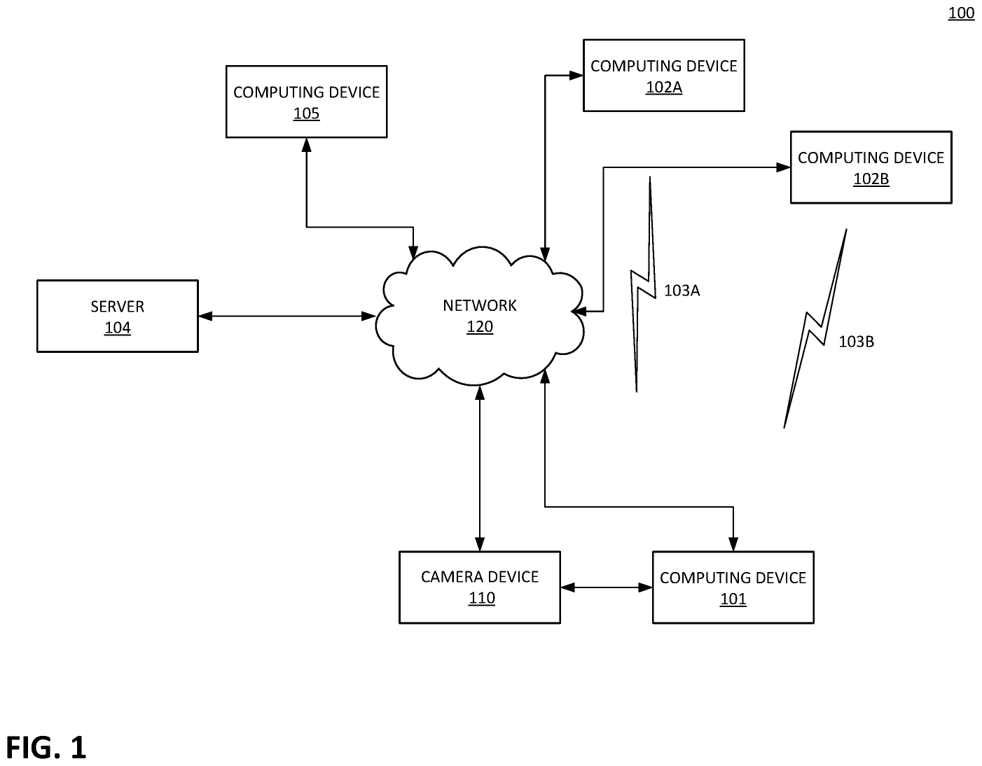

FIG. 1 shows an example system 100. The example system 100 may comprise a computing device 101, a computing device 102a, a computing device 102b, a computing device 105, a camera device 110, and a server 104. The computing device 101 may comprise transmitters, receivers, and/or transceivers for communicating via a network 120 or for communicating directly with other computing devices. The computing device 101 may comprise a camera configured to take pictures and/or record videos. The computing device 101 may comprise, for example, a mobile phone, a smartphone, a desktop computer, a laptop computer, a handheld computer, a tablet, a netbook, a smartwatch, a gaming console, or any other computing device comprising a camera and capable of operating in the network 120. The network 120 may comprise a network such as the Internet or any other network described herein. The network 120 may communicate using technologies such as WLAN technology based on the Institute of Electrical and Electronics Engineers (IEEE) 802.11 standard, wireless cellular technology, Bluetooth, coaxial cable, Ethernet, fiber optics, microwave, satellite, Public Switched Telephone Network (PTSN), Digital Subscriber Line (DSL), BPL, or any other appropriate technologies.

The computing device 101 may send signals, via the network 120, to the computing device 102a, the computing device 102b, the computing device 105, the camera device 110, and the server 104. The computing device 101 may receive signals, via the network 120, from the computing device 102a, the computing device 102b, the computing device 105, the camera device 110, and the server 104. The computing device 101 may send signals, via wireless signals 103a and 103b, to the computing device 102a, the computing device 102b, the computing device 105, the camera device 110, and the server 104. The computing device 101 may receive signals, via wireless signals 103a and 103b, from the computing device 102a, the computing device 102b, the computing device 105, the camera device 110, and the server 104. Wireless signals 103a and 103b may be based on Bluetooth signals.

The computing device 101 may be executing a software application that causes the computing device 101 to register with a cloud service associated with the server 104. The computing device 101 may be configured to execute cryptographic hash functions such as Secure Hash Algorithm 1 (SHA-1). The computing device 101 may generate a private key/public key pair for use with the software application. The computing device 101 may provide the public key to the server 104. The server 104 may send a message confirming registration of the computing device 101 and providing identifying information (e.g., an ID number) for the computing device 101.

The computing device 101 may also be associated with a separate camera device 110. The camera device 110 may comprise a camera configured for taking pictures or recording video. The camera device 110 may comprise one or more professional video cameras configured for recording surveillance video for security systems. The camera device 110 may be capable of communicating with the network 120. The camera device 110 may comprise transmitters, receivers, and/or transceivers for communicating via the network 120 or for communicating directly with other computing devices. The camera device 110 may send signals, via the network 120, to the computing device 101, the computing device 102a, the computing device 102b, the computing device 105, and the server 104. The camera device 110 may receive signals, via the network 120, from the computing device 101, the computing device 102a, the computing device 102b, the computing device 105, and the server 104. The camera device 110 may send signals, via wireless signals 103a and 103b, to the computing device 101, the computing device 102a, the computing device 102b, the computing device 105, and the server 104. The camera device 110 may receive signals, via wireless signals 103a and 103b, from the computing device 101, the computing device 102a, the computing device 102b, the computing device 105, and the server 104.

The camera device 110 may be executing a software application that causes the camera device 110 to register with a cloud service associated with the server 104. The camera device 110 may be configured to execute cryptographic hash functions such are SHA-1. The camera device 110 may generate a private key/public key pair for use with the software application. The camera device 110 may provide the public key to the server 104. The server 104 may send a message confirming registration of the camera device 110 and providing identifying information (e.g., an ID number) for the camera device 110.

Computing devices 102a and 102b may operate as witness devices. The computing devices 102a and 102b may comprise devices such as mobile phones that are being carried by users that are captured in the video. The computing device 101 may select the witness devices based on proximity. For example, the computing device 101 may select the witness devices located within a maximum distance from the computing device 101 or camera device 110. The maximum distance may be configured using the software application.

The computing devices 102a and 102b operating as witness devices may comprise transmitters, receivers, and/or transceivers for communicating via the network 120 or for communicating directly with other computing devices. The computing devices 102a and 102b may comprise, for example, mobile phones, smartphones, desktop computers, laptop computer, handheld computers, tablets, netbooks, smartwatches, gaming consoles, or any other computing devices capable of operating in the network 120. The computing devices 102a and 102b may send signals, via the network 120, to the computing device 101, the camera device 110, the computing device 105, and the server 104. The computing devices 102a and 102b may receive signals, via the network 120, from the computing device 101, the camera device 110, the computing device 105, and the server 104. The computing devices 102a and 102b may send signals, via wireless signals 103a and 103b, to the computing device 101, the camera device 110, the computing device 105, and the server 104. The computing devices 102a and 102b may receive signals, via wireless signals 103a and 103b, from the computing device 101, the camera device 110, the computing device 105, and the server 104.

The computing devices 102a and 102b may be executing software applications that cause the computing devices 102a and 102b to register with a cloud service associated with the server 104. The computing devices 102a and 102b may be configured to execute cryptographic hash functions such are SHA-1. The computing devices 102a and 102b may generate private key/public key pairs for use with the software applications. The computing devices 102a and 102b may provide the public keys to the server 104. The server 104 may send messages confirming registration of the computing devices 102a and 102b and providing identifying information (e.g., ID numbers) for the computing devices 102a and 102b.

The computing device 105 may serve as an authentication device for the video. The computing device 105 may comprise, for example, mobile phones, smartphones, desktop computers, laptop computer, handheld computers, tablets, netbooks, smartwatches, gaming consoles, or any other computing devices capable of operating in the network 120. The computing device 105 may comprise transmitters, receivers, and/or transceivers for communicating via the network 120 or for communicating directly with other computing devices. The computing device 105 may send signals, via the network 120, to the computing device 101, the computing device 102a, the computing device 102b, the camera device 110, and the server 104. The computing device 105 may receive signals, via the network 120, from the computing device 101, the computing device 102a, the computing device 102b, the camera device 110, and the server 104. The computing device 105 may send signals, via wireless signals 103a and 103b, to the computing device 101, the computing device 102a, the computing device 102b, the camera device 110, and the server 104. The computing device 105 may receive signals, via wireless signals 103a and 103b, from the computing device 101, the computing device 102a, the computing device 102b, the camera device 110, and the server 104.

The computing device 105 may be executing software applications that cause the computing device 105 to register with a cloud service associated with the server 104. The computing device 105 may be configured to execute cryptographic hash functions such are SHA-1. The computing device 105 may generate a private key/public key pair for use with the software application. The computing device 105 may provide the public key to the server 104. The server 104 may send messages confirming registration of the computing device 105 and providing identifying information (e.g., an ID number) for the computing device 105. The computing device 105 may receive authentication data from the server 104 to cause the computing device 105 to determine whether the video is authentic.

The server 104 may be associated with a cloud service or any other suitable system or other computing platform, capable of communicating with the network 120. The server 104 may store information associated with the computing device 101, the camera device 110, computing devices 102a and 102b, and computing device 105. The stored information may comprise location data associated with the computing device 101, the camera device 110, the computing devices 102a and 102b, and the computing device 105. The location data may be based on GPS data received from the computing device 101, the camera device 110, the computing devices 102a and 102b, and the computing device 105. The stored information may comprise identifying information for the computing device 101, the camera device 110, the computing devices 102a and 102b, and the computing device 105. The identifying information may comprise an identifier such as an ID number for each of the computing device 101, the camera device 110, the computing devices 102a and 102b, and the computing device 105.

The computing device 101 or the camera device 110 may be recording video and may desire for that video to be able to be authenticated. The computing device 101 or the camera device 110 may discover one or more witness devices that may provide authentication data to the computing device 101 or camera device 110 for authentication of the video by another device (e.g., the computing device 105). The computing devices 102a and 102b may be selected as the witness devices. For example, the computing devices 102a and 102b may be selected based on proximity to a camera of the computing device 101 or the camera device 110. The computing devices 102a and 102b (e.g., the witness devices) may receive first information based on the video frames captured by the computing device 101 or the camera device 110. The first information may comprise, for example, a hash of the video frames captured by the camera. The computing devices 102a and 102b (e.g., the witness devices) may send, to the computing device 101 or the camera device 110, second information based on the first information. For example, the computing devices 102a and 102b (e.g., the witness devices) may send back signed versions of the first information (e.g., signed versions of the hash). The second information may also comprise an identifier associated with computing device 102a and an identifier associated with computing device 102b. The computing device 101 or the camera device 110 may generate third information. The third information may comprise a sequence of data comprising at least the second information and at least the first information. For example, the computing device 101 or the camera device 110 may generate third information comprising the signed versions of the hash. The third information may also comprise identifiers associated with the computing devices 102a and 102b (e.g., the witness devices). The third information may also comprise an identifier associated with the computing device 101 or the camera device 110. Fourth information may be generated, by the computing device 101 or the camera device 110, based on a signed hash of the third information. The fourth information may be encoded with the video content. The fourth information may be encoded as metadata. A device (e.g., the computing device 105) performing authentication of the video may receive the video and decrypt the fourth information (e.g., the metadata) using the public key of the computing device 101 or the camera device 110 and the public keys of the computing devices 102a and 102b (e.g., the witness devices). The authentication device may compare the decrypted versions with the expected values and may determine that the video is authentic and unaltered if the they match.

The computing device 101 or the camera device 110 may be recording video and may want that video to be capable of being authenticated. The computing device 101 or the camera device 110 may discover instances of the software applications executing on witness devices in the local area. Discovery of the instances of the software applications executing on witness devices may be via Bluetooth signaling or by receiving location data associated with the witness devices from the server 104 via the network 120. The cloud service associated with the sever 104 may maintain a database of the GPS locations of each device that is executing the software application or that has registered with the cloud service. The computing device 101 or the camera device 110 may select the n witness devices executing the software application (W) and may receive their ID numbers (WID). The n witness devices may, for example, comprise computing devices 102a and 102b.

As the computing device 101 or the camera device 110 are recording video or taking pictures, they may generate first information associated with the video or pictures. For example, the first information may comprise a secure hash of the video/picture frames. For example, the computing device 101 or the camera device 110 may maintain the secure hash based on executing SHA-1. The first information (e.g., the secure hash) may be generated for each frame, for a group of frames of size n, or for only certain selected frames in a sequence of frames. For example, as the computing device 101 or the camera device 110 records video, it may maintain the first information (e.g., the secure hash, SHA-1) for the last n video frames (F).

The computing device 101 or the camera device 110 may send a message comprising the first information to each selected witness device (e.g., the computing devices 102a and 102b). For example, periodically, such as once per second, the computing device 101 or the camera device 110 may send a message comprising F to each selected witness device (e.g., the computing devices 102a and 102b). Each witness device (e.g., the computing devices 102a and 102b) may generate, based on the first information, second information associated with the video or pictures. For example, each witness device (e.g., the computing devices 102a and 102b) may sign F (e.g., encrypt F with their private keys) to generate the second information. Each witness device (e.g., the computing devices 102a and 102b) may send a message to the computing device 101 or the camera device 110 comprising the second information. For example, each witness device (e.g., the computing devices 102a and 102b) may send a message to the computing device 101 or the camera device 110 comprising the signed hash value (WS).

The computing device 101 or the camera device 110 may generate, based on the second information, third information associated with the video or pictures. For example, the computing device 101 or the camera device 110 may generate a sequence of data comprising the frame hash (F), a witness device count (WC), each witness ID number (WID), each witness device signed hash (WS), and the ID (CID) of the computing device 101 or the camera device 110. The generated sequence of data may, for n witness devices, comprise F, WC, WID1, WS1, . . . WIDn, WSn, and CID. The third information may comprise the generated sequence of data.

The computing device 101 or the camera device 110 may generate, based on the third information, fourth information. For example, to generate the fourth information, the computing device 101 or the camera device 110 may calculate a hash of the generated sequence of data, may sign the hash (C) with its own private key, and may concatenate C to the generated data sequence. For example, the fourth information may comprise, for n witness devices, comprise: F, WC, WID1, WS1, . . . WIDn, WSn, CID, and C.

The computing device 101 or the camera device 110 may encode the fourth information associated with the video or pictures. The fourth information may be encoded as metadata. For example, the computing device 101 or the camera device 110 may encode the generated data sequence with the hash C in the video content. For example, the computing device 101 or the camera device 110 may encode the generated data sequence with the hash C as metadata, such as a metadata blob, during the encoding of the data for the video. The metadata may additionally comprise the timestamps and the GPS location data indicating the time the video was recorded and the location of the recording.

The video may be authenticated. A device that is authenticating the video may detect the encoded fourth information (e.g., the metadata) in the video. The authentication device may, for example, comprise computing device 105. The metadata may be encoded in each frame, in each group of frames of size n, or in each selected frame, depending on how the computing device 101 or the camera device 110 decided to maintain the first information (e.g., the secure hash). The computing device 105 may detect the encoded fourth information (e.g., the metadata) in the video and may determine the first information. For example, the computing device 105 may detect the metadata and may recalculate the first information (e.g., hash F) for the frame, group of frames, or selected frames that are associated with the metadata.

The computing device 105 may receive, from the cloud service associated with the sever 104, the public key for each witness device based on detection of each witness device's identifier (e.g., WID). The computing device 105 may verify the second information. For example, the computing device 105 may verify each witness device signed hash (e.g., WS) by decrypting it using each respective public key. The computing device 105 may determine whether the decrypted second information matches the recalculated first information. For example, the computing device 105 may determine whether the decrypted witness device signed hash (WS) matches F.

The computing device 105 may receive, from the cloud service associated with the sever 104, the public key of the computing device 101 or the camera device 110 based on detection of the CID. The computing device 105 may recalculate the fourth information. For example, the computing device 105 may recalculate the hash of F, WC, WID1, WS1, . . . WIDn, WSn, and CID, which may be referred to as CH. The computing device 105 may verify the detected fourth information. For example, the computing device 105 may verify C by decrypting it with the public key of the computing device 101 or the camera device 110. The computing device 105 may determine that the recalculated fourth information matches the detected fourth information. For example, the computing device 105 may determine that C matches CH.

The computing device 105 may determine that the video frames were indeed recorded by computing device 101 or the camera device 110 and that the contents of the video frames have not been modified. For example, if the decrypted second information matches the first information (e.g., if C and CH match) and the recalculated fourth information matches the detected fourth information (e.g., WS matches F), the computing device 105 may determine that the video frames were indeed recorded by computing device 101 or the camera device 110 and that the contents of the video frames have not been modified. If the decrypted second information matches the first information (e.g., if C and CH match) and the recalculated fourth information matches the detected fourth information (e.g., WS matches F), the computing device 105 may also determine that the witness device list has not been modified. For example, at least one of the witness devices may belong to someone in the video, so the computing device 105 may verify that the person pictured in the video was actually there and appeared as shown in the video. Further, the video that has been authenticated using this method, not only has been verified that the video data is not altered, but the computing device 105 may determine, based on the timestamps and the GPS location data, that it was recorded at the time and location indicated by the metadata.

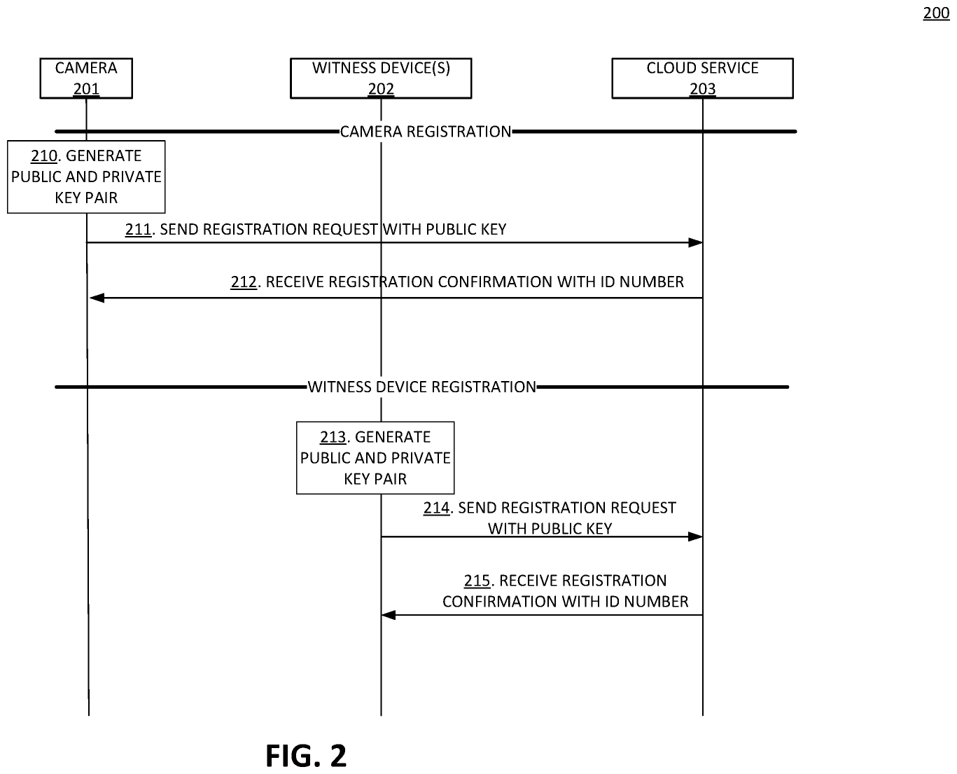

FIG. 2 shows an example flow diagram 200 for registering camera devices and witness devices. A camera 201, such as a camera within the computing device 101 or the camera device 110 depicted in FIG. 1, may generate a public and private key pair (step 210). The camera 201 may send a registration request with its public key to a cloud service 203 (step 211). The cloud service 203 may be associated with server 104 depicted in FIG. 1. The cloud service 203 may send a message confirming registration of the camera 201 and comprising an ID number for the camera 201 (step 212).

Witness devices 202, such as computing devices 102a and 102b depicted in FIG. 1, may generate a public and private key pair (step 213). The witness devices 202 may send a registration request with their public keys to the cloud service 203 (step 214). The cloud service 203 may send messages confirming registration of the witness devices 202 and comprising ID numbers for the witness devices 202 (step 215). The camera 201 and the witness devices 202 that are registered with the cloud service 203 may be discovered by the camera 201 in accordance with the methods described herein.

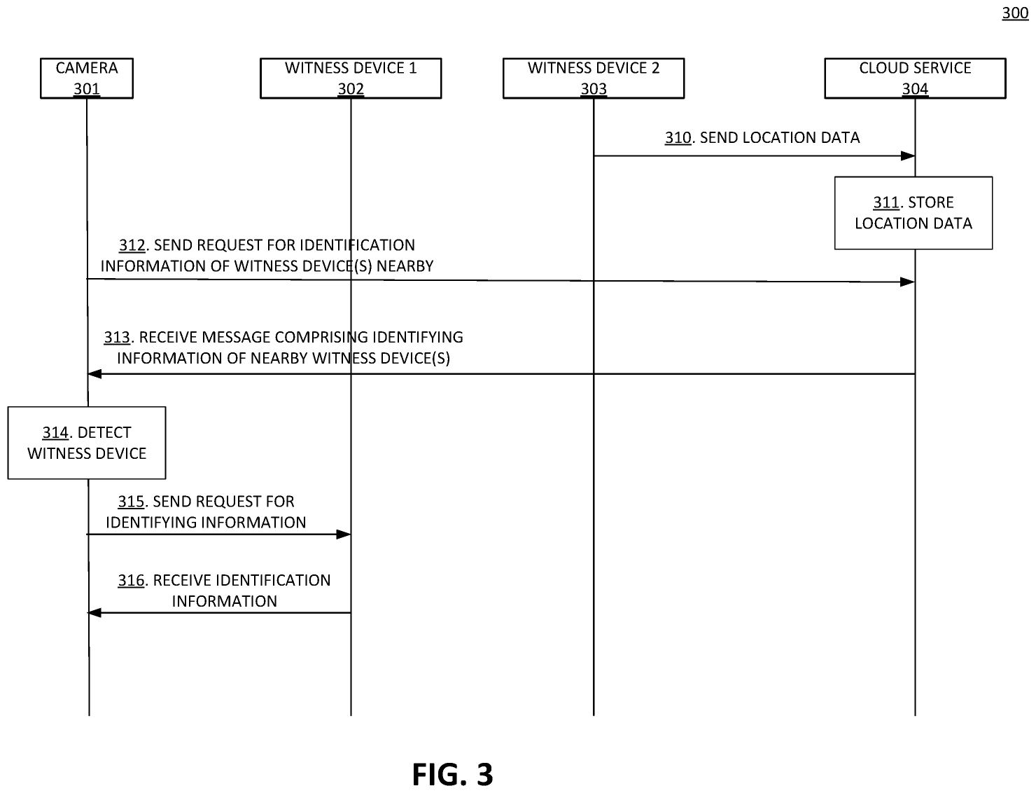

FIG. 3 shows an example flow diagram 300 for discovering witness devices by a camera device. A witness device 2 303, such as computing devices 102a or 102b depicted in FIG. 1, may send location data to a cloud service 304 (step 310). The cloud service 304 may be associated with server 104 depicted in FIG. 1. The location data may comprise GPS locations. The cloud service 304 may store the location data (step 311). The cloud service 304 may maintain a database of the GPS locations for devices that have registered with the cloud service 304, such as based on the procedure 200 of FIG. 2.

A camera 301, such as a camera within the computing device 101 or the camera device 110 depicted in FIG. 1, may send, to the cloud service 304, a request for identification information of any nearby witness devices (step 312). The camera 301 may receive, from the cloud service 304, a message comprising identifying information of nearby witness devices (step 313). The identifying information may comprise the ID number of witness device 2 303, which sent its location data to the cloud service in step 310. The ID number of witness device 2 303 may have been assigned to witness device 2 303 during a registration procedure such as the registration depicted in FIG. 2.

The camera 301 may also detect, via a wireless signal such as a Bluetooth signal, another nearby witness device (step 314). For example, the camera 301 may detect that a witness device 1 302 is nearby. The camera 301 may send, to the witness device 1 302, a request for identification information (step 315). The camera 301 may receive, from the witness device 1 302, a message comprising identifying information of the witness device 1 302 (step 316). The identifying information may comprise the ID number of witness device 1 302. The ID number of witness device 1 302 may have been assigned to witness device 1 302 during a registration procedure such as the registration procedure of FIG. 2.

The camera 301 may discover the witness device 1 302 and witness device 2 303 and may have their identifying information. The camera 301, the witness device 1 302, and witness device 2 303 may perform video authentication in accordance with the methods described herein.

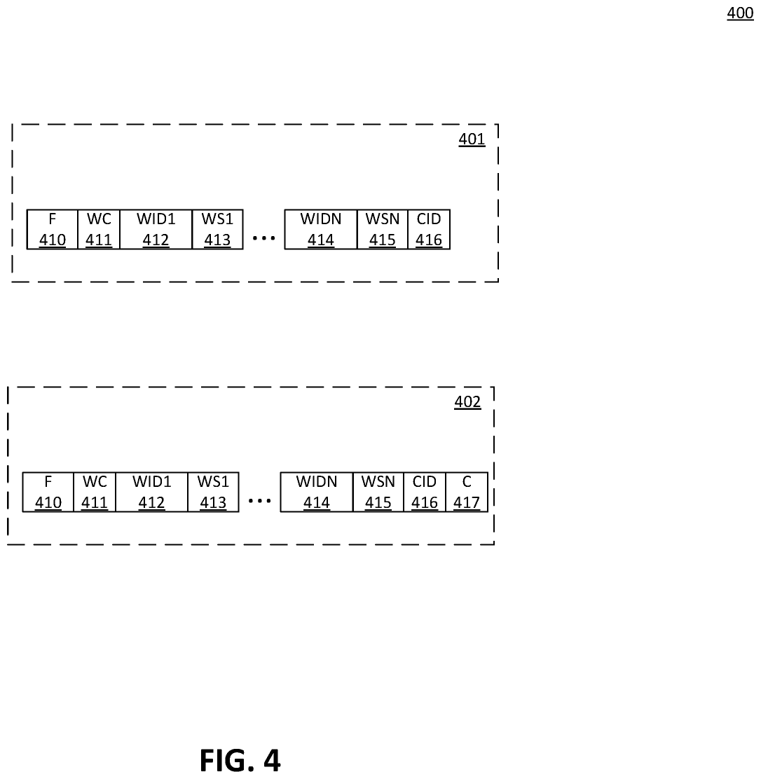

FIG. 4 shows an example of metadata 400 used for authenticating video. FIG. 4 shows the sequence of data 401 generated by a camera device or computing device such as the computing device 101 or the camera device 110 depicted in FIG. 1. The sequence of data 401 comprises the secure hash of the video frames (F 410), a witness device count (WC 411), each witness ID number WID (e.g., WID1 412 . . . WIDn 414), each witness signature (e.g., WS1 413 . . . WSn 415), and the ID (e.g., CID 416) of the computing device 101 or the camera device 110.

FIG. 4 also shows the sequence of data 402 with a signed hash of the sequence of data. The computing device 101 or the camera device 110 may calculate a hash of the sequence of data 401 and may sign the hash with its own private key to generate C 417. The computing device 101 or the camera device 110 may concatenate C 417 to the sequence of data 402.

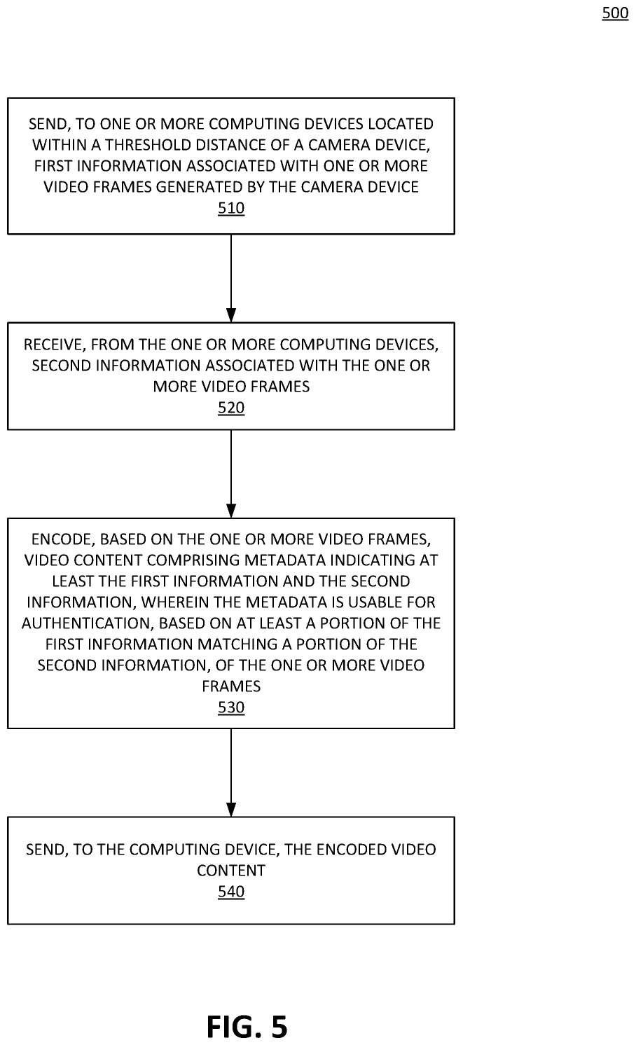

FIG. 5 shows an example method 500. The method 500 of FIG. 5 may be performed by any device, for example, by any of the devices depicted in FIGS. 1 or described herein. While each step in the method 500 of FIG. 5 is shown and described separately, multiple steps may be executed in a different order than what is shown, in parallel with each other, or concurrently with each other.

At step 510, first information, associated with one or more video frames generated by the camera device, may be sent, to one or more computing devices located within a threshold distance of a camera device. The one or more computing devices may comprise witness devices, which are being carried by users that may be recorded in a video. Location data indicating the threshold distance may be provided by a cloud service or by the one or more computing devices themselves. The one or more computing devices may be registered with the cloud service and be discoverable to cameras located nearby that are also registered with the cloud service. The first information may comprise a hash of the one or more video frames captured by the camera device

At step 520, second information associated with the one or more video frames may be received from the one or more computing devices. The second information may comprise one or more signed versions of the first information (e.g., the hash of the one or more video frames captured by the camera device). The one or more signed first hashes may have been signed by the one or more computing devices using their respective private keys, which are registered with the cloud service with their public keys. The second information may comprise one or more identifiers associated with the one or more computing devices. The one or more identifiers may comprise ID numbers for the one or more computing devices.

At step 530, video content comprising metadata may be encoded. The metadata may indicate at least the first information and the second information. The metadata may be usable, by a computing device, for authentication, based on at least a portion of the first information matching a portion of the second information, of the one or more video frames. For example, the metadata may comprise a signed sequence of data. The signed sequence of data may comprise: the first information, the second information, and an identifier of the camera device. For example, the metadata may comprise a second hash generated based at least on: a first hash (e.g., the first information), the one or more signed first hashes, and the one or more identifiers associated with the one or more computing devices. The second hash value may be signed using a private key of the camera device.

At step 540, the encoded video content may be sent to the computing device. The computing device may authenticate the video content by determining that at least a portion of the first information matches a portion of the second information. For example, the first information may comprise a hash of the one or more video frames captured by the camera device, and the computing device may recalculate the hash of the one or more video frames. The second information may comprise one or more signed versions of the first information (e.g., the hash of the one or more video frames captured by the camera device). The computing device may decrypt the one or more signed versions of the first information. The computing device may determine a match among the first information and the decrypted one or more signed versions of the first information.

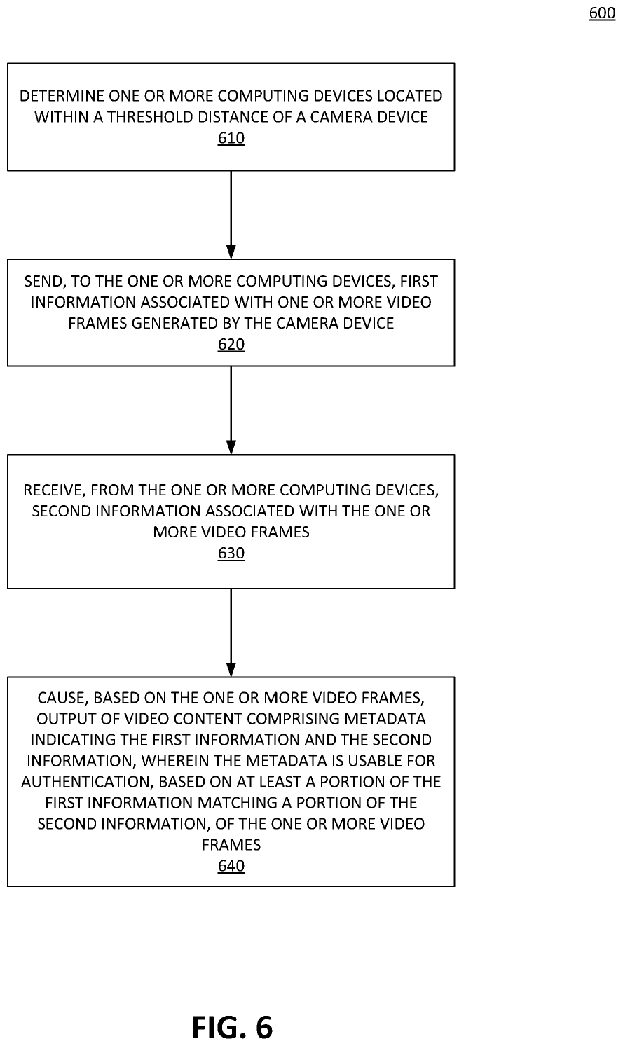

FIG. 6 shows an example method 600. The method 600 of FIG. 6 may be performed by any device, for example, by any of the devices depicted in FIGS. 1 or described herein. While each step in the method 600 of FIG. 6 is shown and described separately, multiple steps may be executed in a different order than what is shown, in parallel with each other, or concurrently with each other.

At step 610, one or more computing devices located within a threshold distance of a camera device may be determined. The one or more computing devices may comprise witness devices, which are being carried by users that may be recorded in a video or picture by the camera device. Location data indicating the threshold distance may be provided by a cloud service or by the one or more computing devices themselves. The one or more computing devices may be registered with the cloud service and be discoverable to cameras located nearby that are also registered with the cloud service.

At step 620, first information, associated with one or more video frames generated by the camera device, may be sent, to one or more computing devices. The first information may comprise a hash of the one or more video frames captured by the camera device. At step 630, second information associated with the one or more video frames may be received from the one or more computing devices. The second information may comprise one or more signed versions of the first information (e.g., the hash of the one or more video frames captured by the camera device). The one or more signed first hashes may have been signed by the one or more computing devices using their respective private keys, which are registered with the cloud service with their public keys. The second information may comprise one or more identifiers associated with the one or more computing devices. The one or more identifiers may comprise ID numbers for the one or more computing devices.

At step 640, video content comprising metadata may be outputted. The metadata may indicate at least the first information and the second information. The metadata may be usable, by a computing device, for authentication, based on at least a portion of the first information matching a portion of the second information, of the one or more video frames. For example, the metadata may comprise a signed sequence of data. The signed sequence of data may comprise: the first information, the second information, and an identifier of the camera device. For example, the metadata may comprise a second hash generated based at least on: a first hash (e.g., the first information), the one or more signed first hashes, and the one or more identifiers associated with the one or more computing devices. The second hash value may be signed using a private key of the camera devices.

The computing device may authenticate the video content by determining that at least a portion of the first information matches a portion of the second information. For example, the first information may comprise a hash of the one or more video frames captured by the camera device, and the computing device may recalculate the hash of the one or more video frames. The second information may comprise one or more signed versions of the first information (e.g., the hash of the one or more video frames captured by the camera device). The computing device may decrypt the one or more signed versions of the first information. The computing device may determine a match among the first information and the decrypted one or more signed versions of the first information.

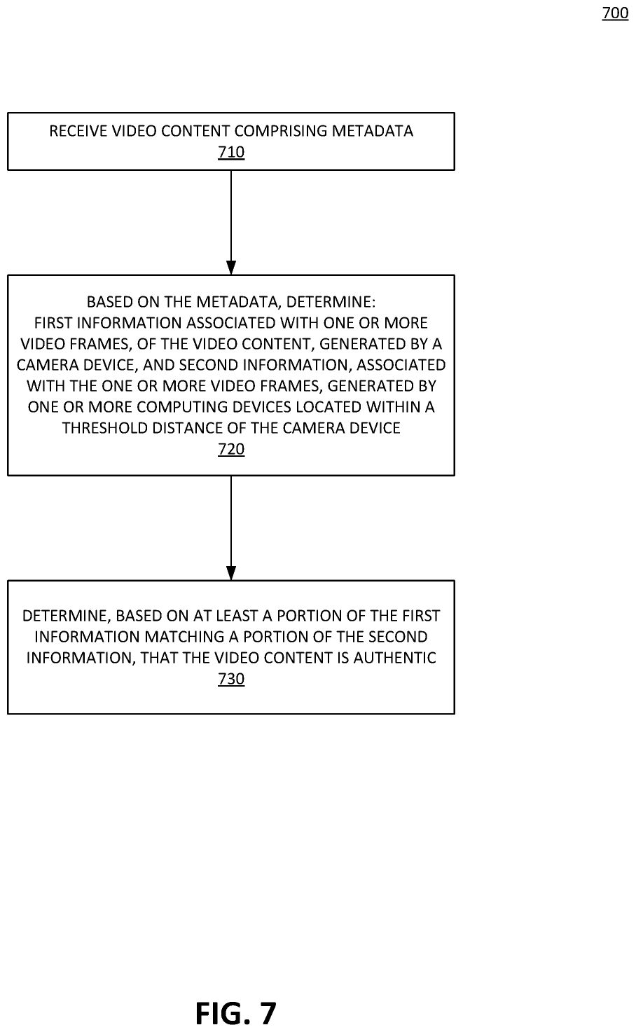

FIG. 7 shows an example method 700. The method 700 of FIG. 7 may be performed by any device, for example, by any of the devices depicted in FIGS. 1 or described herein. While each step in the method 700 of FIG. 7 is shown and described separately, multiple steps may be executed in a different order than what is shown, in parallel with each other, or concurrently with each other.

At step 710, video content associated with a camera device may be received. The video content may comprise metadata. At step 720, based on the metadata, first information associated with one or more video frames of the video content, and second information, associated with the one or more video frames, generated by one or more computing devices located within a threshold distance of the camera device, may be determined. The first information may comprise a hash of the one or more video frames captured by the camera device. The second information may comprise one or more signed versions of the first information (e.g., the hash of the one or more video frames captured by the camera device). The one or more signed first hashes may have been signed by the one or more computing devices using their respective private keys, which are registered with the cloud service with their public keys. The second information may comprise one or more identifiers associated with the one or more computing devices. The one or more identifiers may comprise ID numbers for the one or more computing devices.

The one or more computing devices may comprise witness devices, which are being carried by users that may be recorded in a video or picture by the camera device. Location data indicating the threshold distance may be provided by a cloud service or by the one or more computing devices themselves. The one or more computing devices may be registered with the cloud service and be discoverable to cameras located nearby that are also registered with the cloud service.

At step 730, the video content may be determined to be authentic based on at least a portion of the first information matching a portion of the second information. For example, the metadata may comprise a signed sequence of data. The signed sequence of data may comprise: the first information, the second information, and an identifier of the camera device. For example, the metadata may comprise a second hash generated based at least on: a first hash (e.g., the first information), the one or more signed first hashes, and the one or more identifiers associated with the one or more computing devices. The second hash value may be signed using a private key of the camera device.

The computing device may authenticate the video content by determining that at least a portion of the first information matches a portion of the second information. For example, the first information may comprise a hash of the one or more video frames captured by the camera device, and the computing device may recalculate the hash of the one or more video frames. The second information may comprise one or more signed versions of the first information (e.g., the hash of the one or more video frames captured by the camera device). The computing device may decrypt the one or more signed versions of the first information. The computing device may determine a match among the first information and the decrypted one or more signed versions of the first information.

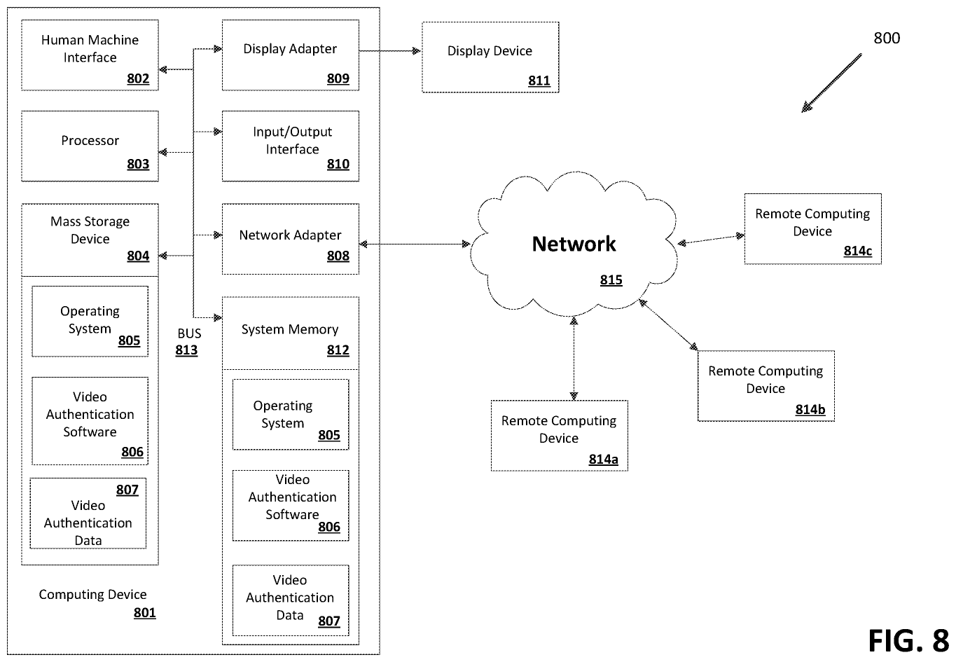

FIG. 8 shows an example operating environment 800. FIG. 8 is not intended to suggest any limitation as to the scope of use or functionality of operating environment architecture. Neither should the operating environment be interpreted as having any dependency or requirement relating to any one or combination of components shown in the example operating environment.

The disclosure described herein may be operational with numerous other general purpose or special purpose computing system environments or configurations. Computing systems, environments, and/or configurations that may be suitable for use with the systems and methods comprise, but are not limited to, personal computers, server computers, laptop devices, and multiprocessor systems. A computing system may comprise set top boxes, programmable consumer electronics, network PCs, minicomputers, mainframe computers, distributed computing environments that comprise any of the above systems or devices, and the like.

The processing described herein may be performed by software components. The embodiments described herein may be described in the general context of computer-executable instructions, such as program modules, being executed by one or more computers or other devices. Generally, program modules comprise computer code, routines, programs, objects, components, data structures, etc. that performs particular tasks or implements particular abstract data types. The embodiments described herein may be practiced in grid-based and distributed computing environments where tasks may be performed by remote processing devices that are linked through a communications network. In a distributed computing environment, program modules may be located in both local and remote computer storage media including memory storage devices.

A computing device 801 may be configured to implement the methods described herein. For example, the computing device 801 may perform any of the methods described herein. The methods of FIGS. 5-7 may be performed by one or more computing devices 801. The components of the computing device 801 may comprise, but are not limited to, one or more processors or processing units 803, a system memory 812, and a system bus 813 that couples various system components including the processor 803 to the system memory 812. In the case of multiple processing units 803, the system may utilize parallel computing.

The system bus 813 represents one or more of several possible types of bus structures, including a memory bus or memory controller, a peripheral bus, an accelerated graphics port, and a processor or a local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB), and/or the like. The bus 813, and all buses specified in this description may be implemented over a wired or wireless network connection and each of the subsystems, including the processor 803, a mass storage device 804, an operating system 805, video authentication software 806, video authentication data 807, a network adapter 808, system memory 812, an Input/Output Interface 810, a display adapter 809, a display device 811, and a human machine interface 802, may be contained within one or more remote computing devices 814a, 814b, 814c at physically separate locations, connected through buses of this form, in effect implementing a fully distributed system.

The computing device 801 typically comprises a variety of computer readable media. Example readable media may be any available media that is accessible by the computing device 801 and may comprise both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as video authentication data 807 and/or program modules such as operating system 805 and video authentication software 806 that are immediately accessible to and/or are presently operated on by the processing unit 803. The video authentication data 807 may comprise location data and identification information for cameras and witness devices.

The computing device 801 may comprise other removable/non-removable, volatile/non-volatile computer storage media. By way of example, FIG. 8 shows a mass storage device 804 that may provide non-volatile storage of computer code, computer readable instructions, data structures, program modules, and other data for the computing device 801. A mass storage device 804 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 804, including by way of example, an operating system 805 and the video authentication software 806. Each of the operating system 805 and the video authentication software 806 (or some combination thereof) may comprise elements of the programming and the video authentication software 806. The video authentication data 807 may be stored on the mass storage device 804. The video authentication data 807 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

A user may enter commands and information into the computing device 801 via an input device (not shown). Examples of such input devices may comprise, but are not limited to, a keyboard, a pointing device (e.g., a “mouse”), a microphone, a joystick, a scanner, tactile input devices such as gloves, and other body coverings, and the like. These and other input devices may be connected to the processing unit 803 via the human machine interface 802 that is coupled to the system bus 813 but may be connected by other interface and bus structures, such as a parallel port, game port, an IEEE 1394 Port (also known as a Firewire port), a serial port, or a universal serial bus (USB).

The display device 811 may be connected to the system bus 813 via an interface, such as the display adapter 809. It is contemplated that the computing device 801 may have more than one display adapter 809 and the computer 801 may have more than one display device 811. A display device may comprise a monitor, an LCD (Liquid Crystal Display), or a projector. The display device 811 and/or other output peripheral devices may comprise components such as speakers (not shown) and a printer (not shown) which may be connected to the computing device 801 via the Input/Output Interface 810. Any step and/or result of the methods may be output in any form to an output device. Such output may comprise any form of visual representation, including, but not limited to, textual, graphical, animation, audio, tactile, and the like. The display device 811 and computing device 801 may comprise part of one device, or separate devices.

The computing device 801 may operate in a networked environment using logical connections to one or more remote computing devices 814a, 814b, 814c. By way of example, a remote computing device may comprise a personal computer, portable computer, a smart phone, a server, a router, a network computer, a peer device or other common network node. Logical connections between the computing device 801 and a remote computing device 814a, 814b, 814c may be made via a network 815, such as a local area network (LAN) and a general wide area network (WAN). Such network connections may be through the network adapter 808. The network adapter 808 may be implemented in both wired and wireless environments. Such networking environments are conventional and commonplace in dwellings, offices, enterprise-wide computer networks, intranets, and the Internet.

For purposes of explanation, application programs and other executable program components such as the operating system 805 are shown herein as discrete blocks, although such programs and components may reside at various times in different storage components of the computing device 801 and may be executed by the data processor(s) of the computer. An implementation of the video authentication software 806 may be stored on or sent across some form of computer readable media. Any of the disclosed methods may be performed by computer readable instructions embodied on computer readable media. Computer readable media may comprise any available media that may be accessed by a computer. By way of example and not limitation, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

What is claimed:

1. A method comprising:
sending, to one or more computing devices located within a threshold distance of a camera device, first information associated with one or more video frames generated by the camera device;
receiving, from the one or more computing devices, second information associated with the one or more video frames;
encoding, based on the one or more video frames, video content comprising metadata indicating at least the first information and the second information, wherein the metadata is usable for authentication, based on at least a portion of the first information matching a portion of the second information, of the one or more video frames; and
sending, to a computing device, the encoded video content.

2. The method of claim 1, wherein the first information comprises a hash of the one or more video frames captured by the camera device.

3. The method of claim 2, wherein the authentication comprises:
recalculating the hash of the one or more video frames.

4. The method of claim 1, wherein the second information comprises:
one or more signed versions of the first information, and
one or more identifiers associated with the one or more computing devices.

5. The method of claim 4, wherein the authentication comprises:
decrypting the one or more signed versions of the first information, and
determining a match among the first information and the decrypted one or more signed versions of the first information.

6. The method of claim 1, wherein the metadata comprises a signed sequence of data, wherein the signed sequence of data comprises: the first information, the second information, and an identifier of the camera device.

7. The method of claim 1, wherein the one or more computing devices are associated with one or more users, and wherein the one or more users are shown in the one or more video frames.

8. The method of claim 1, wherein the authentication indicates that the one or more video frames have not been altered after being generated by the camera device.

9. A method comprising:
determining one or more computing devices located within a threshold distance of a camera device;
sending, to the one or more computing devices, first information associated with one or more video frames generated by the camera device;
receiving, from the one or more computing devices, second information associated with the one or more video frames; and
causing, based on the one or more video frames, output of video content comprising metadata indicating the first information and the second information, wherein the metadata is usable for authentication, based on at least a portion of the first information matching a portion of the second information, of the one or more video frames.

10. The method of claim 9, wherein the first information comprises a hash of the one or more video frames captured by the camera device.

11. The method of claim 10, wherein the authentication comprises:
recalculating the hash of the one or more video frames.

12. The method of claim 9, wherein the second information comprises:
one or more signed versions of the first information, and
one or more identifiers associated with the one or more computing devices.

13. The method of claim 12, wherein the authentication comprises:
decrypting the one or more signed versions of the first information, and
determining a match among the first information and the decrypted one or more signed versions of the first information.

14. The method of claim 9, wherein the metadata comprises a signed sequence of data, wherein the signed sequence of data comprises: the first information, the second information, and an identifier of the camera device.

15. The method of claim 9, wherein the one or more computing devices are associated with one or more users, and wherein the one or more users are shown in the one or more video frames.

16. The method of claim 9, wherein the authentication indicates that the one or more video frames have not been altered after being generated by the camera device.

17. A method comprising:
receiving video content associated with a camera device, wherein the video content comprises metadata;
based on the metadata, determining:
first information associated with one or more video frames of the video content, and
second information, associated with the one or more video frames, generated by one or more computing devices located within a threshold distance of the camera device; and
sending, based on at least a portion of the first information matching a portion of the second information, a message indicating that the video content is authentic.

18. The method of claim 17, wherein the message indicates that the one or more video frames have not been altered after being generated by the camera device.

19. The method of claim 17, wherein the one or more computing devices are associated with one or more users, and wherein the one or more users are shown in the one or more video frames.

20. The method of claim 17, wherein the second information comprises:
one or more signed versions of the first information, and
one or more identifiers associated with the one or more computing devices.
